(19) United States
(12) Patent Application Publication
(10) Pub. No.: US 2020/0127930 A1
(43) Pub. Date: Apr. 23, 2020

(54) SYSTEM AND METHOD FOR ACCELERATING REMOTE DATA OBJECT ACCESS AND/OR CONSUMPTION

(71) Applicant: R-Stor Inc., Saratoga, CA (US)

(72) Inventors: Damian Kowalewski, Sunnyvale, CA (US); Roger Levinson, Monte Sereno, CA (US)

(21) Appl. No.: 16/002,808

(22) Filed: Jun. 7, 2018

(51) Int. Cl. H04L 12/801; H04L 29/08

(52) U.S. Cl. CPC H04L 47/34; H04L 67/145

(57) ABSTRACT

Systems and apparatus for accelerating remote data object processing and methods for making and using the same. In various embodiment, these technologies are used to initiate processing of data parcels by a remote server immediately upon receipt and without waiting for additional data parcels to arrive among other things.

### FIELD

The present disclosure relates generally to data object processing and more particularly, but not exclusively, to systems and methods for accelerating remote data processing.

### BACKGROUND

Conventional computer networks comprise a plurality of interconnected servers, computers and other network components. The various network components can communicate in a wired and/or wireless manner. As a part of this communication, data objects are exchanged among the network components typically via data packets in accordance with a communication protocol standard, such as Transmission Control Protocol (TCP) and/or User Datagram Protocol (UDP). The same communication protocol standard is used to transmit the data packets as the data packets traverse the computer network from a source network component to a destination network component.

Processing data objects, however, can be problematic, especially when the data objects are stored at a first network component but are to be processed by a second network component that is remote from the first network component. Transmitting data objects, particularly large data objects, to the remote network component can take significant time. In addition, conventional network components require the entire data object to be transferred to the remote network component before the remote network component can begin processing the data object. Accordingly, processing data objects via remote network components can give rise to substantial system latency.

In view of the foregoing, a need exists for an improved system and method for accelerating remote data processing in an effort to overcome the aforementioned obstacles and deficiencies of conventional computer networks.

### BRIEF DESCRIPTION OF THE DRAWINGS

FIG. 1 is an exemplary top-level drawing illustrating an embodiment of a computer network with a predetermined arrangement of network components.

FIG. 2 is an exemplary top-level drawing illustrating an alternative embodiment of the computer network of FIG. 1, wherein data associated with a first network component can be transmitted to a second network component for processing.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

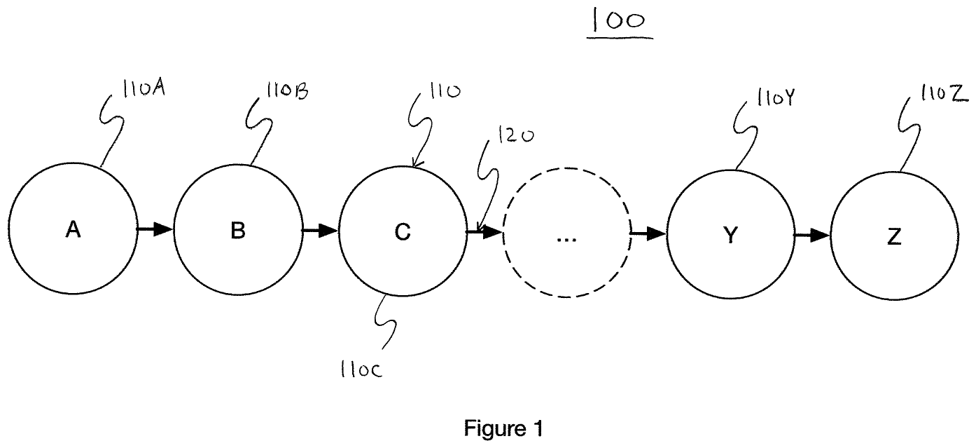

Since currently-available computer networks introduce significant delay in the transmission and processing of data objects via remote network components, a computer network that accelerates remote data processing can prove desirable and provide a basis for a wide range of computer applications. This result can be achieved, according to one embodiment disclosed herein, by a computer network 100 as illustrated in FIG. 1.

Turning to FIG. 1, the computer network 100 is shown as including a plurality of interconnected network components (or resources). These network components can include server systems 110 that are configured to communication with one or more other server systems 110 via at least one communication connection 120. Each server system 110 can comprise a computer or a computer program for managing access to a centralized resource (or service) in the network; whereas, each communication connection 120 can support one or more selected communication protocols and preferably comprises a bi-directional communication connection. Exemplary communication protocols can include Transmission Control Protocol (TCP), User Datagram Protocol (UDP) Remote Direct Memory Access (RDMA), RDMA over Converged Ethernet (RoCE), InfiniBand (IB) or any combination thereof, without limitation.

At a proximal end region of the computer network 100, a first server 110A is shown as being in communication with a second server 110B via a first communication connection 120. The second server 110B can be in communication with a third server 110C via a second communication connection 120 and so on. At a distal end region of the computer network 100, a Z^{th} server 110Z is shown as being in communication with a Y^{th} server 110Y via a Y^{th} communication connection 120. Although shown and described with reference to FIG. 1 as comprising a sequence of server systems 110 for purposes of illustration only, the computer network 100 can include any predetermined number of network components, which can be arranged in any desired configuration. Additionally and/or alternatively, any selected number of intermediate servers 110 can be disposed between the first server 110A and the Z^{th} server 110Z. In other words, the first server 110A and the Z^{th} server 110Z can communicate directly in one embodiment or can communicate via one or more intermediate servers 110 in other embodiments.

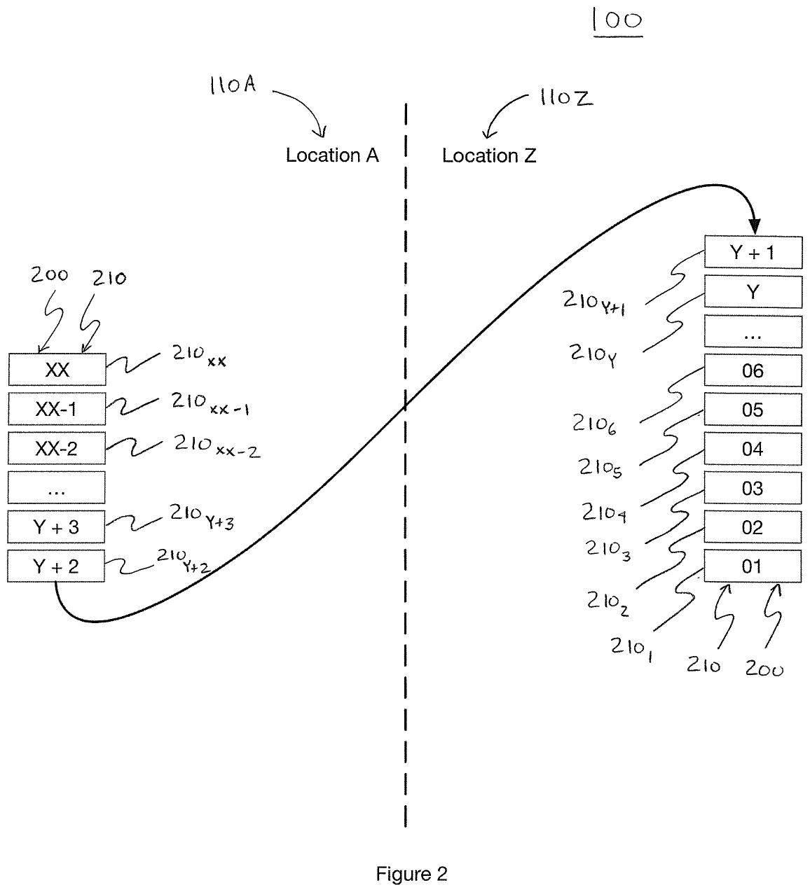

In one embodiment, data object can be stored at the proximal end region of the computer network 100 and intended to be processed at the distal end region of the computer network 100. Turning to FIG. 2, for example, data object 200 is shown as being stored in the first server 110A and intended to be processed by the Z^{th} server 110Z, which is remote from the first server 110A. The data 200 can be provided in any conventional manner and/or format. In one embodiment, the data 200 can comprise one or more data packets.

Advantageously, the computer network 100 can initiate anticipate processing of the data 200. The Z^{th} server 110Z, for example, can begin processing the data 200 as the data 200 is being received by Z^{th} server 110Z. In other words, the Z^{th} server 110Z does not need to wait for the data 200 to be received in its entirety from the first server 110A before initiating processing of the data 200. Instead, the Z^{th} server 110Z can begin to process each portion of the data 200 as each data portion arrives. The Z^{th} server 110Z preferably can begin processing the data portions immediately upon arrival at the Z^{th} server 110Z, and the data processing can continue while other data portions are being received from the first server 110A.

As illustrated in FIG. 2, the data 200 can be divided into a predetermined number XX of data parcels 210. The data parcels 210 can include any suitable amount of data and preferably comprise small data parcels to minimize latency and otherwise facilitate transmission from the first server 110A to the Z^{th} server 110Z. Exemplary data parcel sizes can include 1 MB, 2 MB, 4 MB, 8 MB, 16 MB, 64 MB, 128 MB, etc., without limitation. The data parcels 210 can have uniform and/or different data parcel sizes. Preferably, the data parcels 210 for a selected data object have a uniform data parcel size.

The data parcels 210 initially are stored at the first server 110A. Once divided into the predetermined number XX of data parcels 210, the data parcels 210 can be stored as a sequence of data parcels 210: a first data parcel 210₁; a second data parcel 210₂; a third data parcel 210₃; a fourth data parcel 210₄; . . . ; a Y^{th} data parcel 210_{Y}; a Y+1^{st} data parcel 210_{Y+1}; a Y+2^{nd} data parcel 210_{Y+2}; a Y+3^{rd} data parcel 210_{Y+3}; . . . ; a XX−2^{nd} data parcel 210_{XX-2}; a XX−1^{st} data parcel 210_{XX-1}; and a XX^{th} data parcel 210_{XX} as shown in FIG. 2. The data parcels 210 can be transmitted from the first server 110A to the Z^{th} server 110Z in any predetermined manner, preferably in the sequence beginning with the first data parcel 210₁ and ending with the XX^{th} data parcel 210_{XX}.

Upon receiving the first data parcel 210₁, the Z^{th} server 110Z can initiate processing of the first data parcel 210₁ without waiting for the second data parcel 210₂ or any other data parcels 210 to arrive. While the Z^{th} server 110Z processes the first data parcel 210₁, other data parcels 210, such as the second data parcel 210₂, can arrive at the Z^{th} server 110Z. The Z^{th} server 110Z can initiate processing of the second data parcel 210₂ once processing of the first data parcel 210₁ is complete and without waiting for the third data parcel 210₃ or any other data parcels 210 to arrive. Other data parcels 210, such as the third data parcel 210₃, can arrive at the Z^{th} server 110Z while the Z^{th} server 110Z processes the first data parcel 210₁ and/or the second data parcel 210₂. The Z^{th} server 110Z can initiate processing of the third data parcel 210₃ once processing of the second data parcel 210₂ is complete and without waiting for the fourth data parcel 210₄ or any other data parcels 210 to arrive. The Z^{th} server 110Z can continue to receive and process data parcels 210 in the manner set forth above until the XX^{th} data parcel 210_{XX} has been received and processed.

If the Z^{th} server 110Z completes processing of a selected data parcel 210 before the next data parcel 210 in the sequence arrives, a complete read operation can be utilized to block further data processing operations by the Z^{th} server 110Z until the next data parcel 210 fully arrives. In other words, the Z^{th} server 110Z does not return an end of data indication to the application if the next data parcel 210 in the sequence does not timely arrive. The Z^{th} server 110Z, instead, can keep the data connection to the application open. In one embodiment, the Z^{th} server 110Z can keep the data connection open by pretending to be, or otherwise indicating, that the Z^{th} server 110Z is in a “slow read” mode or a “read delay” mode of operation, rather than closing the data connection.

In one embodiment, transmission of the data 200 from the first server 110A to the Z^{th} server 110Z can include transmission of metadata associated with the data 200. The metadata can include an object size for the data 200 and/or a number of data parcels 210 that comprise the data 200 and preferably is received by the Z^{th} server 110Z before the first data parcel 210₁ arrives at the Z^{th} server 110Z. The transmission and processing of the data 200 thereby can be performed in a manner that is transparent to an operating system and an application way of the computer network 100.

Although various implementations are discussed herein and shown in the figures, it will be understood that the principles described herein are not limited to such. For example, while particular scenarios are referenced, it will be understood that the principles described herein apply to any suitable type of computer network, including, but not limited to, a Local Area Network (LAN), a Wide Area Network (WAN), a Wireless Local Area Network (WLAN), a Metropolitan Area Network (MAN) and/or a Campus Area Network (CAN).

Accordingly, persons of ordinary skill in the art will understand that, although particular embodiments have been illustrated and described, the principles described herein can be applied to different types of computer networks. Certain embodiments have been described for the purpose of simplifying the description, and it will be understood to persons skilled in the art that this is illustrative only. It will also be understood that reference to a “server,” “computer,” “network component” or other hardware or software terms herein can refer to any other type of suitable device, component, software, and so on. Moreover, the principles discussed herein can be generalized to any number and configuration of systems and protocols and can be implemented using any suitable type of digital electronic circuitry, or in computer software, firmware, or hardware. Accordingly, while this specification highlights particular implementation details, these should not be construed as limitations on the scope of any invention or of what may be claimed, but rather as descriptions of features that may be specific to particular embodiments of particular inventions.

1. A method for accelerating remote data access or consumption, comprising:
dividing data available at a first network component into a sequence of data parcels; and
serially transmitting the sequence of data parcels to a second network component being distal from the first network component,
wherein the second network component initiates processing of a first data parcel in the sequence upon receipt of the first data parcel and without waiting for a second data parcel in the sequence to arrive at the second network component, and
wherein the second network component immediately initiates the processing of the first data parcel upon receipt of the first data parcel.

2. The method of claim 1, wherein said dividing the data comprises dividing the data into a predetermined number of data parcels having a uniform size.

3. The method of claim 2, wherein said dividing the data comprises dividing the data into the data parcels each having a predetermined size selected from a group consisting of 1 Megabyte, 2 Megabytes, 4 Megabytes, 8 Megabytes, 16 Megabytes, 64 Megabytes and 128 Megabytes.

4. (canceled)

5. (canceled)

6. The method of claim 1, wherein the second network component initiates processing of the second data parcel in the sequence upon receipt of the second data parcel once the processing of the first data parcel is complete.

7. The method of claim 6, wherein the second network component initiates the processing of the second data parcel without waiting for a third data parcel in the sequence to arrive at the second network component.

8. The method of claim 1, wherein the second network component initiates the processing of each successive data parcel in the sequence upon receipt of the successive data parcel.

9. The method of claim 1, wherein the second network component initiates the processing of each successive data parcel in the sequence upon receipt of the successive data parcel.

10. The method of claim 1, further comprising blocking further data operations by the second network component once the processing of the first data parcel is complete and until the second data parcel fully arrives at the second network component.

11. The method of claim 10, wherein said blocking the further data operations comprises issuing a complete read operation by the second network component.

12. The method of claim 10, wherein said blocking the further data operations includes maintaining an open data connection between the first network component and the second network component until the second data parcel fully arrives at the second network component.

13. The method of claim 12, wherein said maintaining the open data connection includes placing the second network component in a slow read mode or a read delay mode of operation.

14. A computer program product for accelerating remote data access or consumption, the computer program product being encoded on one or more non-transitory machine-readable storage media and comprising:
instruction for dividing data available at a first network component into a sequence of data parcels; and
instruction for serially transmitting the sequence of data parcels to a second network component being distal from the first network component,
wherein the second network component initiates processing of a first data parcel in the sequence upon receipt of the first data parcel and without waiting for a second data parcel in the sequence to arrive at the second network component, and
wherein the second network component immediately initiates the processing of the first data parcel upon receipt of the first data parcel.

15. A system for accelerating remote data access or consumption, comprising:
a first network component for dividing selected data into a sequence of data parcels and serially transmitting the sequence of data parcels; and
a second network component being distal from said first network component and for receiving the transmitted sequence of data parcels and initiating processing of a first data parcel in the sequence upon receipt of the first data parcel and without waiting for a second data parcel in the sequence to arrive at said second network component,
wherein the second network component immediately initiates the processing of the first data parcel upon receipt of the first data parcel.

16. The system of claim 15, wherein said second network component maintains an open data connection with said first network component until the second data parcel fully arrives at said second network component.

17. The system of claim 16, wherein said first network component and said second network component are associated with a computer network, and wherein the open data connection includes one or more intermediate network components between said first network component and said second network component.

18. The system of claim 17, wherein the computer network comprises a network topology selected from a group consisting of a Local Area Network (LAN), a Wide Area Network (WAN), a Wireless Local Area Network (WLAN), a Metropolitan Area Network (MAN) and a Campus Area Network (CAN).

19. The system of claim 15, wherein said second network component initiates processing of the second data parcel in the sequence upon receipt of the second data parcel and once the processing of the first data parcel is complete.

20. The system of claim 15, wherein said second network component blocks further data operations once the processing of the first data parcel is complete and until the second data parcel fully arrives at the second network component.
